(19) United States
(12) Patent Application Publication
(10) Pub. No.: US 2014/0253830 A1
(43) Pub. Date: Sep. 11, 2014

(54) TOUCH DISPLAY APPARATUS

(71) Applicants: Chong-Wei Li, Changhua County (TW); Ching-Fu Hsu, Taichung City (TW); Tsung-Yu Wang, Taichung City (TW)

(72) Inventors: Chong-Wei Li, Changhua County (TW); Ching-Fu Hsu, Taichung City (TW); Tsung-Yu Wang, Taichung City (TW)

(73) Assignees: WINTEK CORPORATION, Taichung City (TW); WINTEK (CHINA) TECHNOLOGY LTD., Guangdong Province (CN)

(21) Appl. No.: 14/200,039

(22) Filed: Mar. 7, 2014

(30) Foreign Application Priority Data
Mar. 8, 2013 (TW) 102108294

(51) Int. Cl. G06F 3/041

(52) U.S. Cl. CPC G06F 3/041
USPC 349/12

(57) ABSTRACT

A touch display apparatus including a display panel and touch panel is provided. The display panel includes a first surface, a second surface and a first turning corner therebetween. The touch panel includes a flexible substrate having a first area, a second area and a first folding area, touch sensing electrodes, and transmission lines. The touch sensing electrodes are disposed on the first area and traverse across the first area in a direction. The transmission lines electrically connected to the touch sensing electrodes substantially traverse across the first folding area and extend from the first area to the second area. The material of the transmission lines at the first folding area includes metal. When the touch panel is attached on the display panel, the first area, the second area and the first folding area are respectively attached on the first surface, the second surface and the first turning corner.

### CROSS-REFERENCE TO RELATED APPLICATION

This application claims the priority benefit of Taiwan application serial no. 102108294, filed on Mar. 8, 2013. The entirety of the above-mentioned patent application is hereby incorporated by reference herein and made a part of this specification.

### BACKGROUND

1. Technical Field

The invention relates to a touch display apparatus. Particularly, the invention relates to a touch display apparatus having a narrow border.

2. Related Art

Along with the flourishing development of electronic technology, the current products are designed in a trend of integrating a tough panel with a display panel to construct a touch display panel. Regarding the fabrication of a commonly used touch display panel, the touch panel and the display panel are separately fabricated and then the touch panel is attached on the display panel.

The touch panel includes a plurality of touch sensing electrodes and transmission lines respectively connected to the corresponding touch sensing electrodes. In order to have a larger screen and satisfy the design requirements of thinness, simplicity and narrow border, the space on the touch panel used for configuring the transmission lines is limited, and a line width of each transmission line has to be decreased. However, the inadequate line width may increase a resistance value of the transmission line, which leads to the attenuation and the delay of the sensing signals transmission and further influences on the operation sensitivity of the touch panel. Therefore, the touch panel is still required to be improved to satisfy the requirements of narrow border and good signal transmission quality.

### SUMMARY

The invention is directed to a touch display apparatus, which has a narrow border and good signal transmission quality.

The invention provides a touch display apparatus including a display panel and a touch panel attached on the display panel. The display panel includes a first surface, a second surface and a first turning corner between the first surface and the second surface. A normal vector of the first surface is intersected with a normal vector of the second surface. The touch panel includes a flexible substrate, a plurality of touch sensing electrodes and a plurality of transmission lines. The flexible substrate has a first area, a second area and a first folding area, where the first area, the first folding area and the second area are sequentially arranged along a direction. The touch sensing electrodes are disposed on the flexible substrate and located in the first area, and the touch sensing electrodes substantially traverse across the first area along the direction. The transmission lines are electrically connected to the touch sensing electrodes and substantially traverse across the first folding area and extend from the first area to the second area. A material of the transmission lines at the first folding area includes metal. When the touch panel is attached on the display panel, the first area, the second area and the first folding area are respectively attached on the first surface, the second surface and the first turning corner.

In an embodiment of the invention, a radius of curvature of the first folding area is not greater than 6 mm.

In an embodiment of the invention, when the touch panel is attached on the display panel, the touch sensing electrodes and the transmission lines are located between the flexible substrate and the display panel.

In an embodiment of the invention, the touch panel is attached on the display panel through an optical adhesive.

In an embodiment of the invention, the touch panel further includes a decoration layer located on the second area and the first folding area, where the decoration layer is configured between the flexible substrate and the transmission lines.

In an embodiment of the invention, the touch display apparatus further includes a shielding electrode layer located between the touch panel and the display panel.

In an embodiment of the invention, the flexible substrate of the touch panel further includes a third area and a second folding area located between the second area and the third area. The touch panel further includes a plurality of side touch sensing electrodes configured in the second area. A part of the transmission lines are electrically connected to the side touch sensing electrodes, and the transmission lines further traverse across the second folding area and extend to the third area. The display panel further has a third surface and a second turning corner between the third surface and the second surface. When the touch panel is attached on the display panel, the third area is attached on the third surface and the second folding area is attached on the second turning corner. In an embodiment, a radius of curvature of the second folding area is not greater than 6 mm.

In an embodiment of the invention, the touch display apparatus further includes a flexible circuit board connected to the transmission lines.

In an embodiment of the invention, the transmission lines and the touch sensing electrodes are made of metal and at least the metal of the touch sensing electrodes is patterned in the form of mesh.

In an embodiment of the invention, the transmission lines are respectively formed by a solid metal pattern.

In an embodiment of the invention, the first surface is a display surface.

In an embodiment of the invention, the display panel is a self-luminous display panel, a non-self-luminous display panel or a combination thereof.

In an embodiment of the invention, the touch display apparatus further includes an antenna unit and a shielding electrode layer, where the shielding electrode layer is disposed between the antenna unit and the display panel, and the display panel is located between the antenna unit and the touch panel.

In an embodiment of the invention, the touch panel further comprises a plurality of side touch sensing electrodes configured in the second area, and a part of the transmission lines are electrically connected to the side touch sensing electrodes. The touch panel further comprises a decoration layer disposed on the flexible substrate, the decoration layer has a plurality of openings corresponding to the side touch sensing electrodes to define at least one function pattern. The display panel has a first surface with a first normal vector and a second surface with a second normal vector intersected to the first normal vector, the display panel displays images of function patterns on the second surface and the function patterns correspond to the side touch sensing electrodes to provide a side operation interface.

According to the above description, in the touch display apparatus of the invention, the transmission lines configured on the flexible substrate are disposed on a surface outside the main display surface (or the touch surface) of the display panel through the flexibility of the flexible substrate. In this way, an edge of the display surface, i.e. a border area can be narrowed, and even a borderless design is substantially achieved. Moreover, since the transmission lines are made of a metal material, the transmission lines still have an ideal signal transmission characteristic in case that the flexible substrate is folded. Particularly, the transmission lines can be made of solid metal patterns, respectively so as to improve the transmission effect.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are respectively a top view and a cross-sectional view of a touch panel according to an embodiment of the invention, where the cross section of FIG. 1B corresponds to a sectional line I-I.

FIG. 2 is a schematic diagram of a touch display apparatus according to an embodiment of the invention, where the touch display apparatus of the embodiment includes the touch panel shown in FIG. 1A.

FIG. 3 is a cross-sectional view of the touch display apparatus of FIG. 2, which corresponds to a section line II-II.

FIG. 4 is a cross-sectional view of a touch display apparatus according to another embodiment of the invention.

FIG. 5A and FIG. 5B are respectively a top view and a cross-sectional view of a touch panel according to another embodiment of the invention, where the cross section of FIG. 5B corresponds to a sectional line III-III.

FIG. 6 is a schematic diagram of a touch display apparatus according to still another embodiment of the invention, where the touch display apparatus of the embodiment includes the touch panel shown in FIG. 5A.

FIG. 7 is a cross-sectional view of the touch display apparatus of FIG. 6, which corresponds to a section line IV-IV.

FIG. 8 is a schematic diagram of a touch display apparatus according to still another embodiment of the invention.

### DETAILED DESCRIPTION OF DISCLOSED EMBODIMENTS

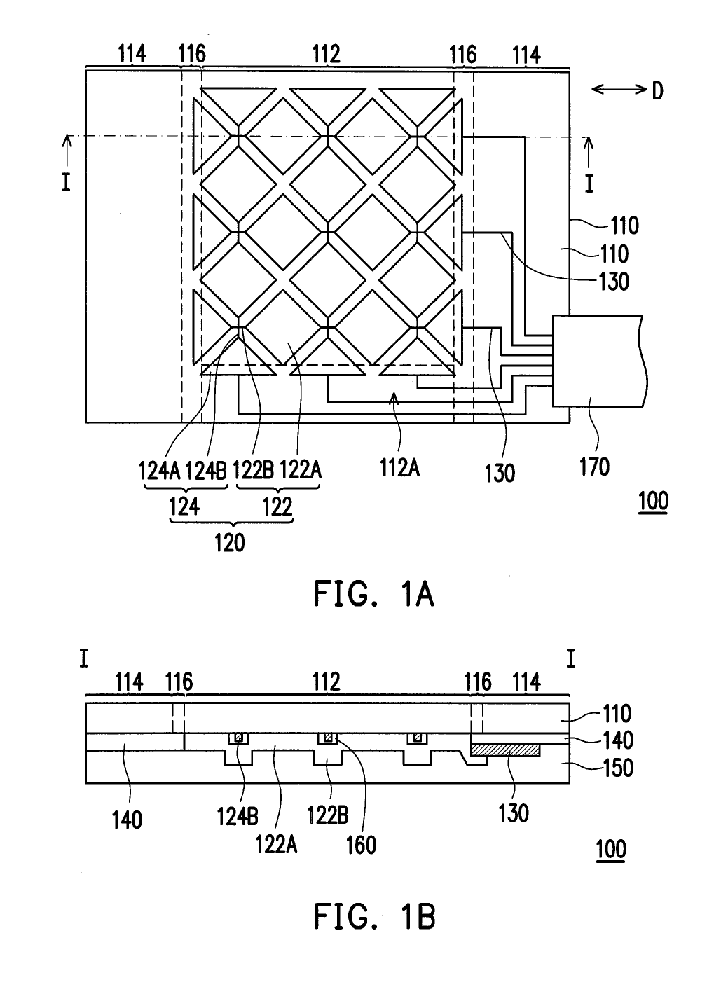

FIG. 1A and FIG. 1B are respectively a top view and a cross-sectional view of a touch panel according to an embodiment of the invention, where the cross section of FIG. 1B corresponds to a sectional line I-I. Referring to FIG. 1A and FIG. 1B, the touch panel 100 includes a flexible substrate 110, a plurality of touch sensing electrodes 120, a plurality of transmission lines 130, a decoration layer 140 and a passivation layer 150 wherein the touch sensing electrodes 120 can be self capacitance type or mutual capacitance type. The flexible substrate 110 is, for example, a plastic substrate and is made of the materials having a characteristic of flexibility (for example, PMMA, PET and PC). The touch sensing electrodes 120, the transmission lines 130, the decoration layer 140 and the passivation layer 150 are all configured on the flexible substrate 110. The decoration layer 140 is disposed corresponding to a position of the transmission lines 130. Moreover, to avoid the exposure of the touch sensing electrodes 120, the touch sensing electrodes 120 and the transmission lines 130 are disposed between the flexible substrate 110 and the passivation layer 150.

The flexible substrate 110 has a first area 112, a second area 114 and a first folding area 116, where the first folding area 116 is located between the first area 112 and the second area 114. Moreover, in the present embodiment, the number of the second areas 114 is, for example, two, and the two second areas 114 are respectively located at two opposite sides of the first area 112 along a direction D, and a normal vector of the first area 112 is substantially intersected with a normal vector of the second area 114. However, the number and the arrangement method of the aforementioned areas are only examples, which are not used to limit the invention.

The touch sensing electrodes 120 are disposed on the first area 112, and each includes a plurality of first series 122 and a plurality of second series 124. The first series 122 are strings respectively extending along the direction D, and the second series 124 are strings with extending directions intersected to the direction D. Here, each of the first series 122 includes a plurality of sensing pads 122A and a plurality of bridge lines 122B, and each of the bridge lines 122B is connected between two sensing pads 122A. Similarly, each of the second series 124 includes a plurality of sensing pads 124A and a plurality of bridge lines 124B, and each of the bridge lines 124B is connected between two sensing pads 124A. The sensing pads 122A and 124A and the bridge lines 122B and 124B are made of the same or different material, like metal, transparent conductive material or a combination thereof, where the metal material constituting the touch sensing electrodes 120 can be patterned in the form of mesh patterns. Moreover, a fabrication sequence of the sensing pads 122A and 124A and the bridge lines 122B and 124B can be adjusted, so that a stacking sequence of the sensing pads 122A and 124A and the bridge lines 122B and 124B outward from the flexible substrate 110 is not particularly specified.

In the present embodiment, the first sensing string 122 and the second sensing string 124 are electrically independent to each other. Therefore, the first sensing string 122 and the second sensing string 124 can be separated through multiple insulation patterns 160. However, the method of using the series to serve as the touch sensing electrodes 120 of the touch panel 100 is only used as an example, and is not used to limit the invention. In other embodiments, the touch sensing electrodes 120 can be a plurality of bar-shape touch sensing electrodes, a plurality of independent pattern touch sensing electrodes or touch sensing electrodes formed by single layer. When the touch sensing electrodes 120 has a design that the conductive patterns are not intersected to each other, the touch panel 100 may not be configured with the insulation pattern 160.

The transmission lines 130 disposed on the flexible substrate 110 are used for transmitting sensing or driving signals of the touch sensing electrodes 120. Therefore, the transmission lines 130 are respectively connected to the corresponding touch sensing electrodes 120. In the present embodiment, each of the transmission lines 130 is connected to one of the first series 122 and the second series 124. Moreover, one end of each of the transmission lines 130 is connected to one of the touch sensing electrodes 120 located on the first area 112, and another end thereof is located on the second area 114. Namely, each of the transmission lines 130 extends from the first area 112 to the second area 114 and traverses across the first folding area 116. Since one end of each of the transmission lines 130 is located on the second area 114, the touch panel 100 may further include a flexible circuit board 170 electrically connected to the transmission lines 130 within the second area 114.

The decoration layer 140 is generally used to shield the transmission lines 130 to avoid the user viewing the transmission lines 130. Therefore, in the present embodiment, the decoration layer 140 can be disposed on the first folding area 116 and the second area 114. The decoration layer 140 is a layer having a light shielding function, and a material thereof can be photoresist, ink, diamond-like carbon, ceramic or a combination of the above materials. In addition, the decoration layer 140 is made form one or more layers stacked with each other. In the present embodiment, besides that the decoration layer 140 is disposed on the second area 114 and the first folding area 116, the decoration layer 140 can also be selectively disposed on the first area 112. For example, the decoration layer 140 can be disposed on a part region 112A of the first area 122 configured with the transmission lines 130. In other embodiment, the transmission lines 130 connected to the first series 122 can be extended to the part region 112A such that the transmission lines 130 connected to the first series 122 and the second series 124 are located within the same side of the flexible substrate 110 for connecting to the flexible circuit board 170 conveniently.

In the present embodiment, the components on the flexible substrate 110 that traverse across the first folding area 116 are mainly the transmission lines 130 made of metal. For example, the transmission lines 130 are, for example, made of a pure metal material or an alloy of pure metals, or a metal mesh formed by metal wires, where the metal wires can be nano-silver wires, though the invention is not limited thereto. Therefore, the transmission lines 130 can be folded without influencing the transmission quality of the sensing signal. In addition, the transmission lines 130 can be respectively formed by a solid metal pattern for increasing the transmission effect.

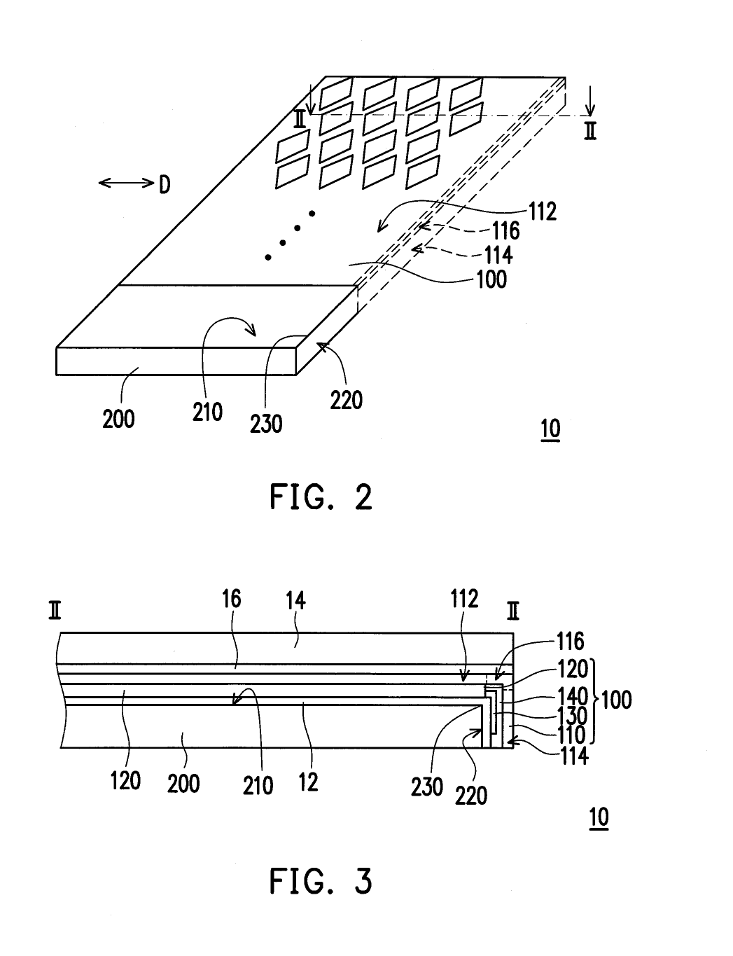

For example, FIG. 2 is a schematic diagram of a touch display apparatus according to an embodiment of the invention, where the touch display apparatus of the present embodiment includes the touch panel shown in FIG. 1A. Referring to FIG. 1A and FIG. 2, the touch display apparatus 10 includes the aforementioned touch panel 100 and a display panel 200, where the display panel 200 can be a non-self-luminous display panel, a self-luminous display panel or a combination thereof. Regarding the self-luminous display panel, it includes an organic light-emitting display panel, an electroluminescent display panel, etc. Regarding the non-self-luminous display panel, it includes a liquid crystal display panel, an electrophoretic display panel, an electro-wetting display panel, etc. Moreover, the display panel 200 can be a flexible display panel or a rigid display panel, and the type of the display panel 200 is not limited by the invention.

In the present embodiment, the display panel 200 is a plate-shape component, which generally has six surfaces. Here, in order to clearly describe the configuration of the touch panel 100, two of the surfaces, i.e. a first surface 210 and a second surface 220 of the display panel 200 are indicated for descriptions. In the present embodiment, the first surface 210 is a display surface of the display panel 200. Namely, the user directly views the first surface 210 to obtain displayed images. Moreover, the second surface 220 is a side surface of the display panel 200.

The first area 112 of the touch panel 100 is, for example, attached on the first surface 210, and the second area 114 is, for example, attached on the second surface 220. It should be noticed that the transmission lines 130 configured on the first folding area 116 are made of a metal material with good conductivity and extensibility. Under a situation that the flexible substrate 110 is significantly folded, the impedance of the transmission lines 130 is not greatly increased. A radius of curvature of the first folding area 116 of the touch panel 100 can be smaller than 6 mm or even decreased to 4 mm, or even less, and the transmission lines 130 still have an ideal transmission characteristic. Therefore, the first folding area 116 of the touch panel 100 can be attached to a first turning corner 230 between the first surface 210 and the second surface 220.

When the display panel 200 has a narrow border design, a width of a displayed image is, for example, required to be approaching or even equal to a width of the first surface 210 along the direction D as far as possible. Now, since the first area 112 of the touch panel 100 is attached on the first surface 210, the second area 114 is attached on the second surface 220 and the first folding area 116 is attached on the first turning corner 230, a configuration width of the touch sensing electrodes 120 in the touch panel 100 is, for example, at least correspondingly equal to the width of the first surface 210 along the direction D. In this way, a width of the region of touch display apparatus 10 capable of providing the display function and the touch sensing function along the direction D can be equal to the width of the first surface 210 along the direction D, i.e. a borderless touch display apparatus 10 is substantially achieved.

FIG. 3 is a cross-sectional view of the touch display apparatus of FIG. 2, which corresponds to a section line II-II. Referring to FIG. 2 and FIG. 3, in the touch display apparatus 10, the touch panel 100 can be attached on the display panel 200 through an optical adhesive 12. Now, the touch sensing electrodes 120, the transmission lines 130 and the decoration layer 140 of the touch panel 100 are, for example, all sandwiched between the flexible substrate 110 and the display panel 200. Moreover, the touch display apparatus 10 may further include a cover plate 14, and the cover plate 14 is attached on the touch panel 100 through another optical adhesive 16.

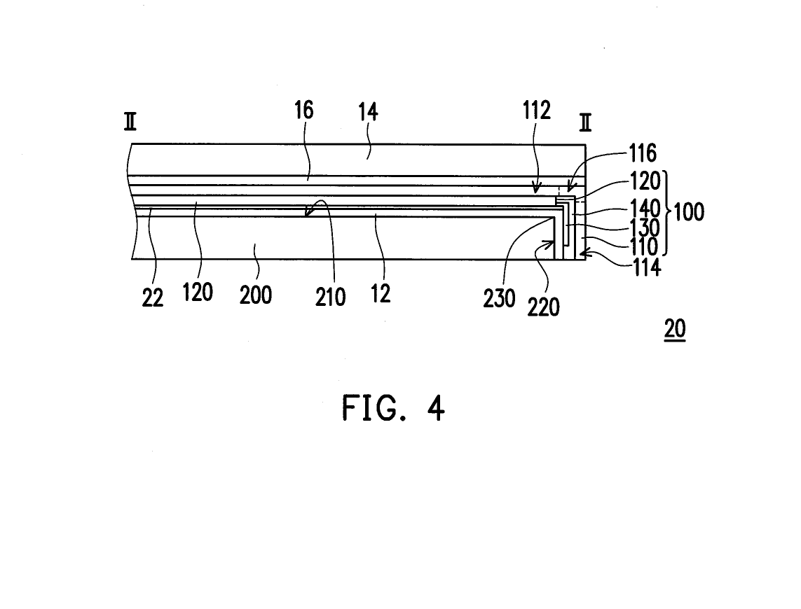

FIG. 4 is a cross-sectional view of a touch display apparatus according to another embodiment of the invention. Referring to FIG. 4, the touch display apparatus 20 is similar to the touch display apparatus 10, and the same or similar components in the two embodiments are denoted by the same or similar device symbols, and are not reiterated. In the touch display apparatus 20 of the present embodiment, a shielding electrode layer 22 is further disposed between the touch panel 100 and the display panel 200 to decrease signal interference therebetween. In the present embodiment, the shielding electrode layer 22 is first fabricated on the touch panel 100, and then is attached on the display panel 200 through the optical adhesive 12. Alternatively, the shielding electrode layer 22 is first fabricated on the first surface 210 of the display panel 200, and then the touch panel 100 is attached on the display panel 200 through the optical adhesive 12. Namely, the configuration positions of the optical adhesive 12 and the shielding electrode layer 22 can be exchanged.

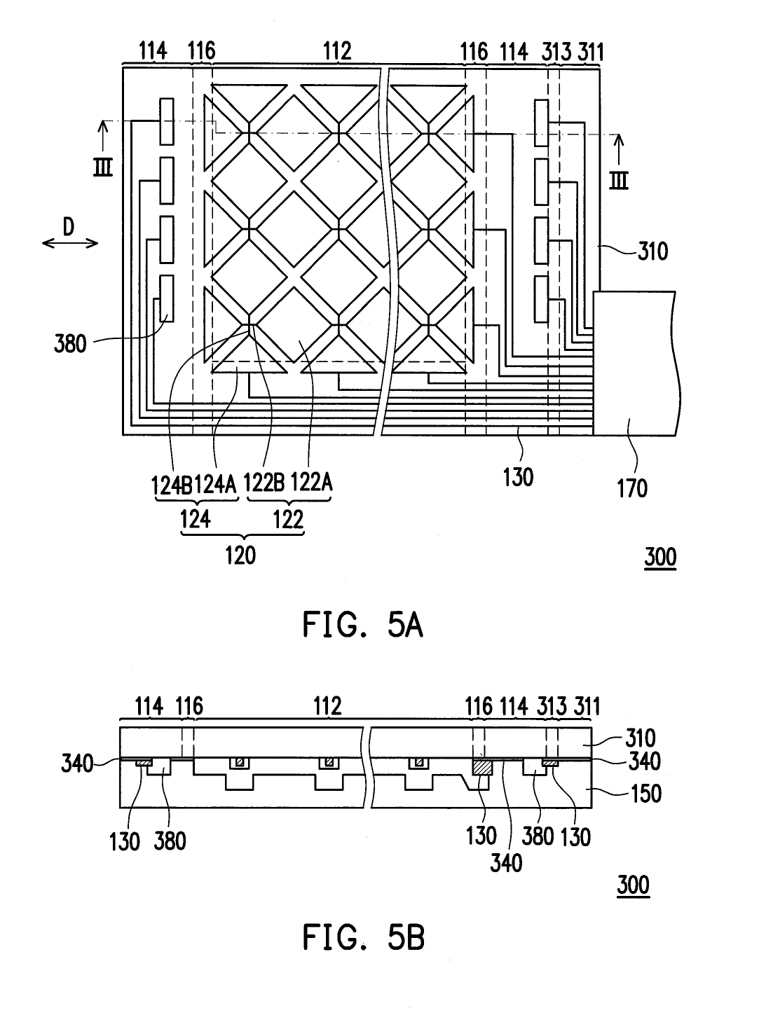

FIG. 5A and FIG. 5B are respectively a top view and a cross-sectional view of a touch panel according to another embodiment of the invention. Referring to FIG. 5A and FIG. 5B, the touch panel 300 includes a flexible substrate 310, a plurality of touch sensing electrodes 120, a plurality of transmission lines 130, a decoration layer 340, a passivation layer 150, a flexible circuit board 170 and a plurality of side touch sensing electrodes 380. The flexible substrate 310 is, for example, a plastic substrate or other substrate with flexibility. The touch sensing electrodes 120, the transmission lines 130, the decoration layer 340, the passivation layer 150 and the side touch sensing electrodes 380 are all disposed on the flexible substrate 310. The decoration layer 340 is disposed corresponding to a position of the transmission lines 130, and the decoration layer 340 has openings corresponding to the side touch sensing electrodes 380 wherein the openings define at least one functional patterns. Namely, the side touch sensing electrodes 380 may selectively not be covered by the decoration layer 340, though the invention is not limited thereto. Moreover, a light transmitting material, such as colored ink, is disposed within the openings and between the side touch sensing electrodes 380 and the flexible substrate 310. The touch sensing electrodes 120, the transmission lines 130 and the side touch sensing electrodes 380 are all sandwiched between the flexible substrate 310 and the passivation layer 150. Moreover, the flexible circuit board 170 is connected to the transmission lines 130.

Further, in the present embodiment, the flexible substrate 310 includes the first area 112, two second areas 114, two first folding areas 116, a third area 311 and a second folding area 313. From the left to the right of FIG. 5, the areas are sequentially one second area 114, one first folding area 116, the first area 112, the other first folding area 116, the other second area 114, the second folding area 313 and the third area 311. Namely, the second folding area 313 is disposed between the second area 114 and the third area 311, such that the second area 114 and the third area 311 are located at two opposite sides of the second folding area 313 along the direction D. The flexible circuit board 170 is connected to the transmission lines 130 at the third area 311.

In the present embodiment, the setting, the material and the configuration of the touch sensing electrodes 120 may refer to the description of the aforementioned embodiment, and details thereof are not reiterated. In the touch panel 300 of the present embodiment, besides that the first area 112 is configured with the touch sensing electrodes 120, the second area 114 is further configured with the side touch sensing electrodes 380. Moreover, a part of the transmission lines 130 are connected to the side touch sensing electrodes 380. In addition, one end of each of the transmission lines 130 is connected to one of the touch sensing electrodes 120 and the side touch sensing electrodes 380, and another end thereof is located on the third area 311. Namely, besides that the transmission lines 130 traverse across the first folding area 116, the transmission lines 130 further traverse across the second folding area 313 and extend to the third area 311.

Similar to the aforementioned embodiment, the transmission lines 130 are made of metal with good conductivity and extensibility, metal mesh or a combination thereof. When the first folding area 116 and the second folding area 313 traversed across by the transmission lines 130 are significantly folded, the impedance of the transmission lines 130 is not obviously increased such that the transmission lines 130 have an ideal signal transmission quality. Therefore, in the present embodiment, when the touch panel 300 is applied to the touch display apparatus, the first folding area 116 and the second folding area 313 can be set to positions to be folded.

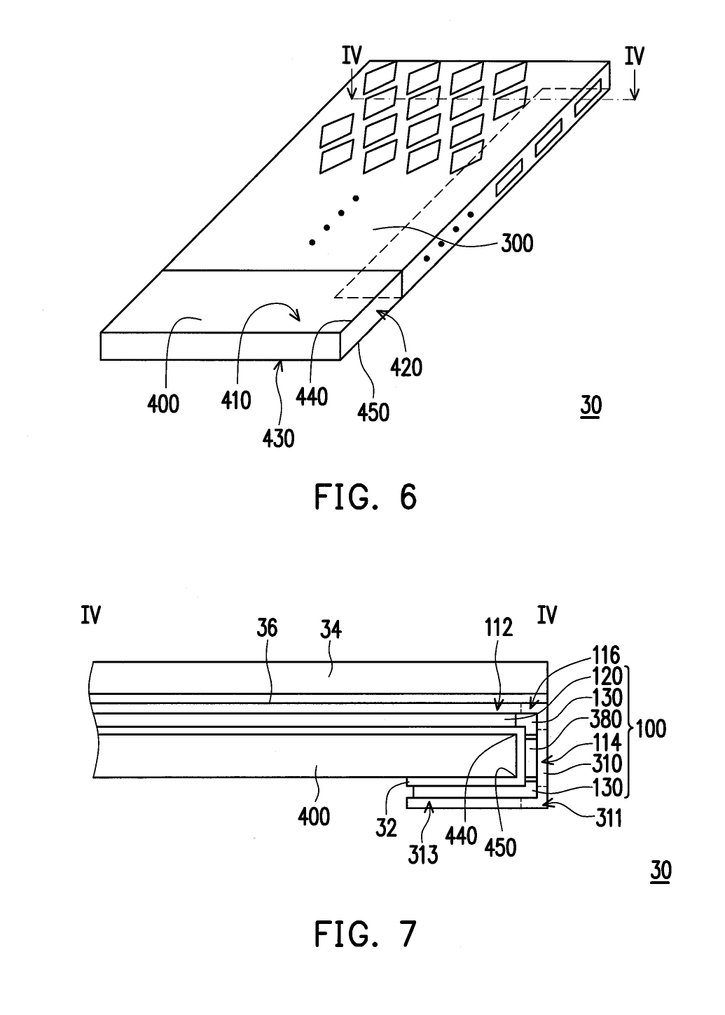

For example, FIG. 6 is a schematic diagram of a touch display apparatus according to still another embodiment of the invention, where the touch display apparatus of the present embodiment includes the touch panel of FIG. 5A. Moreover, FIG. 7 is a cross-sectional view of the touch display apparatus of FIG. 6, which corresponds to a section line IV-IV. Referring to FIG. 5A, FIG. 6 and FIG. 7, the touch display apparatus 30 includes the aforementioned touch panel 300 and a display panel 400, where the display panel 400 can be a non-self-luminous display panel, a self-luminous display panel or a combination thereof. Regarding the self-luminous display panel, it includes an organic light-emitting display panel, an electroluminescent display panel, etc. Regarding the non-self-luminous display panel, it includes a liquid crystal display panel, an electrophoretic display panel, an electro-wetting display panel, etc. Moreover, the display panel 400 can be a flexible display panel or a rigid display panel, and the type of the display panel 400 is not limited by the invention. The touch panel 300 is attached on the display panel 400 through an optical adhesive 32, and a cover plate 34 is attached on the flexible substrate 310 of the touch panel 300 through another optical adhesive 36.

In the present embodiment, three of the surfaces of the display panel 400 are indicated for descriptions, where a first surface 410, a second surface 420 and a third surface 430 are respectively a display surface, a side surface and a bottom surface. Normal vectors of the first surface 410 and the second surface 420 are intersected to each other, so that the first surface 410 and the second surface 420 have a first turning corner 440 therebetween. Moreover, normal vectors of the second surface 420 and the third surface 430 are intersected to each other, so that the second surface 420 and the third surface 430 have a second turning corner 450 therebetween.

When the touch panel 300 is attached on the display panel 400, the first area 112 of the touch panel 300 is attached on the first surface 410, the second area 114 of the touch panel 300 is attached on the second surface 420, and the third area 311 of the touch panel 300 is attached on the third surface 430. Moreover, in the present embodiment, the first folding area 116 of the touch panel 300 is correspondingly attached to the first turning corner 440 and the second folding area 313 is correspondingly attached to the second turning corner 450.

The conductive components, i.e. the transmission lines 130 traversed across the first folding area 116 and the second folding area 313 are made of a conductive material with good extensibility. When the first folding area 116 and the second folding area 313 are folded corresponding to the first turning corner 440 and the second turning corner 450, the transmission lines 130 maintain the good signal transmission quality. Moreover, the radius of curvature of the first folding area 116 and the second folding area 313 can be smaller than 6 mm, even smaller than 4 mm.

Moreover, in the design of the present embodiment, the first area 112 is substantially covered with the touch sensing electrodes 120 along the direction D. Therefore, an area of the touch sensing electrodes 120 capable of providing the touch sensing function substantially traverses across the width of the first area 112 along the direction D, so as to achieve the narrow border design. Moreover, in the present embodiment, the side surface of the display panel 400, i.e. the second surface 420 is attached with the side touch sensing electrodes 380. Therefore, the touch display apparatus 30 has the touch sensing function at the side surface.

In an embodiment, the side touch sensing electrodes 380 may correspond to positions of functional patterns provided by the openings of the decoration layer 340, or the display panel 400 may display the images of the function patterns on the second surface 420 corresponding to a situation that the side touch sensing electrodes 380 provide a side operation interface. When the touch display apparatus 30 is a handheld product, for example, a mobile phone, a tablet or the like, the side touch sensing electrodes 380 probably conduct a false sensing due to user's holding. Namely, the action that the user contacts the side surfaces of the touch display apparatus 30 for holding it may be misinterpreted as a touch operation. Now, the region where the side touch sensing electrodes 380 locate can be shielded through a design of casing package of the touch display apparatus 30, so as to avoid the false sensing caused by the holding action of the user. Alternatively, signals with contact areas greater than a predetermined value are all set to mistouch signals, for example, a signal processing method of “palm rejection” is used. Alternatively, during a period that the side touch sensing electrodes 380 are not used, the sensing function of the side touch sensing electrodes 380 is disabled, and when side touch sensing electrodes 380 are to be used, the sensing function of the side touch sensing electrodes 380 is enabled. In other words, when the side touch sensing electrodes 380 are configured, the false sensing caused by the holding action of the user can be avoided through software calculation, hardware casing design, software control, etc.

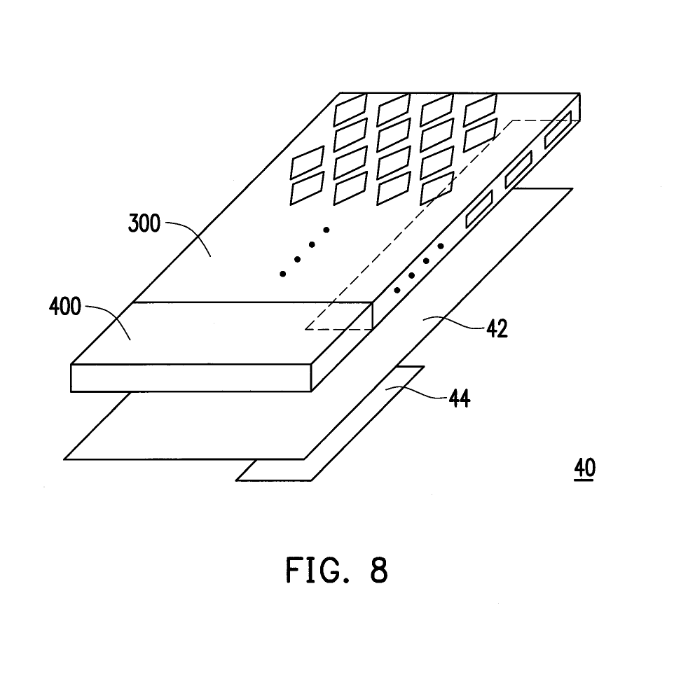

In FIG. 7, the shielding electrode layer 22 of FIG. 4 can be selectively disposed between the display panel 400 and the touch panel 300 to decrease the signal interference between the two panels. Moreover, FIG. 8 is a schematic diagram of a touch display apparatus according to still another embodiment of the invention. Referring to FIG. 8, the touch display apparatus 40 has all of the components of the aforementioned touch display apparatus 30, and further includes a shielding electrode layer 42 and an antenna unit 44. In the present embodiment, the shielding electrode layer 42 is located between the antenna unit 44 and the display panel 400, and the display panel 400 is located between the antenna unit 44 and the touch panel 300, so as to mitigate the signal interference between the antenna unit 44 and the touch panel 300.

In summary, the flexible touch panel is attached on the display panel and a configuration area of the transmission lines are folded to the side surface or the back surface outside the main display surface. Therefore, the touch display apparatus of the invention substantially has a narrow border or is substantially borderless, so as to have a design requirement of a large size screen. Since the components of the touch panel disposed in the folding area are made of a material with good extensibility and conductivity, in case that the folding area of the touch panel is folded, the components still maintain the ideal signal transmission quality. Therefore, the touch panel of the invention may have the narrow border design while maintaining the ideal signal transmission quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display apparatus, comprising:
a display panel; and
a touch panel, attached on the display panel, and comprising:
a flexible substrate, having a first area, a second area and a first folding area located between the first area and the second area, wherein a normal vector of the first area is substantially intersected with a normal vector of the second area;
a plurality of touch sensing electrodes, disposed on the flexible substrate and located in the first area; and
a plurality of transmission lines, electrically connected to the touch sensing electrodes, and substantially traversing across the first folding area and extending from the first area to the second area.

2. The touch display apparatus as claimed in claim 1, wherein a radius of curvature of the first folding area is not greater than 6 mm.

3. The touch display apparatus as claimed in claim 1, wherein the touch sensing electrodes and the transmission lines are located between the flexible substrate and the display panel.

4. The touch display apparatus as claimed in claim 1, further comprising an optical adhesive disposed between the touch panel and the display panel.

5. The touch display apparatus as claimed in claim 1, wherein the touch panel further comprises a decoration layer disposed on the flexible substrate and corresponding to the second area and the first folding area, and the decoration layer is configured between the flexible substrate and the transmission lines.

6. The touch display apparatus as claimed in claim 1, further comprising a shielding electrode layer located between the touch panel and the display panel.

7. The touch display apparatus as claimed in claim 1, wherein the flexible substrate further comprises a third area and a second folding area located between the second area and the third area, the touch panel further comprises a plurality of side touch sensing electrodes configured in the second area, a part of the transmission lines are electrically connected to the side touch sensing electrodes, and the transmission lines further traverse across the second folding area and extend to the third area.

8. The touch display apparatus as claimed in claim 7, wherein the display panel has a first surface, a second surface, a third surface, a first turning corner between the first surface and the second surface, and a second turning corner between the third surface and the second surface, the first, the second and the third areas are attached on the first, the second and the third surfaces, the first folding area is attached on the first turning corner and the second folding area is attached on the second turning corner.

9. The touch display apparatus as claimed in claim 8, wherein a radius of curvature of the second folding area is not greater than 6 mm.

10. The touch display apparatus as claimed in claim 8, wherein the first surface is a display surface.

11. The touch display apparatus as claimed in claim 1, further comprising a flexible circuit board connected to the transmission lines.

12. The touch display apparatus as claimed in claim 1, wherein the transmission lines and the touch sensing electrodes are made of metal and at least the metal of the touch sensing electrodes is patterned in the form of mesh.

13. The touch display apparatus as claimed in claim 1, wherein the transmission lines are respectively formed by a solid metal pattern.

14. The touch display apparatus as claimed in claim 1, wherein the display panel is a self-luminous display panel, a non-self-luminous display panel or a combination thereof.

15. The touch display apparatus as claimed in claim 1, further comprising an antenna unit and a shielding electrode layer, wherein the shielding electrode layer is disposed between the antenna unit and the display panel, and the display panel is located between the antenna unit and the touch panel.

16. The touch display apparatus as claimed in claim 1, further comprising a cover plate attached on the touch panel.

17. The touch display apparatus as claimed in claim 1, wherein the display panel comprises a first surface, a second surface and a first turning corner between the first surface and the second surface, a normal vector of the first surface is intersected with a normal vector of the second surface, and the first area, the second area and the first folding area of the flexible substrate are respectively attached on the first surface, the second surface and the first turning corner of the display panel.

18. The touch display apparatus as claimed in claim 1, wherein a material of the transmission lines at the first folding area comprises metal.

19. The touch display apparatus as claimed in claim 1, wherein the touch panel further comprises a plurality of side touch sensing electrodes configured in the second area, and a part of the transmission lines are electrically connected to the side touch sensing electrodes.

20. The touch display apparatus as claimed in claim 19, wherein the touch panel further comprises a decoration layer disposed on the flexible substrate, the decoration layer has a plurality of openings corresponding to the side touch sensing electrodes to define at least one function pattern.

21. The touch display apparatus as claimed in claim 19, wherein the display panel has a first surface with a first normal vector and a second surface with a second normal vector intersected to the first normal vector, the display panel displays images of function patterns on the second surface and the function patterns correspond to the side touch sensing electrodes to provide a side operation interface.
